(19) United States
(12) Patent Application Publication
(10) Pub. No.: US 2007/0073577 A1
(43) Pub. Date: Mar. 29, 2007

(54) System and Method of Real Estate Market Growth Analysis and Display

(75) Inventors: Peter Krause, Glen Ellen, CA (US); Timothy Frazer, Glen Ellen, CA (US); William D. Biggs, Santa Rosa, CA (US); Joshua Michael Rymer, Glen Ellen, CA (US); Mark Spraetz, Overland Park, KS (US)

Correspondence Address: COATS & BENNETT, PLLC, P O BOX 5, RALEIGH, NC, 27602, US

(73) Assignee: Terradatum, Inc., Glen Ellen, CA (US)

(21) Appl. No.: 11/556,419

(22) Filed: Nov. 3, 2006

Related U.S. Application Data
(63) Continuation-in-part of application No. 11/065,893, filed on Feb. 25, 2005.
(60) Provisional application No. 60/548,220, filed on Feb. 27, 2004.

(51) Int. Cl. G06F 17/30

(52) U.S. Cl. 705/10

(57) ABSTRACT

Data extracted from the Multiple Listing Service (MLS) or similar database are mined to analyze and display real estate market growth. A plurality of selection criteria that define a real estate market is accepted and two time period definitions are also accepted. Data associated with properties in the defined real estate market sold during the two time periods and retrieved from the MLS are aggregated. The data are analyzed to determine the growth in the defined real estate market between the two time periods and indications of the growth are graphically displayed. The displays may be as percent change or change in value of a metric, and may comprise single and double bar graphs, respectively, each bar or pair of bars graphing the metric for a geographic area or for a real estate office. The metrics may include dollar volume, number of units, median price, average commission, and average days on market.

### RELATED APPLICATIONS

This application is a continuation-in-part of Ser. No. 11/065,893, filed Feb. 25, 2005, which claims priority to Provisional U.S. Patent Application 60/548,220 filed Feb. 27, 2004, both of which are incorporated herein by reference in their entireties.

### BACKGROUND

The present invention relates generally to the field of software and in particular to software products that provide analysis and display of real estate market growth data to support improved and efficient management of real estate businesses.

Advances in information technology have revolutionized business management practices in industries across the spectrum. However, the buying and selling of real estate remains largely a face-to-face operation. Additionally, the management of real estate businesses—from individual agents to national real estate enterprises comprising thousands of real estate offices—has been slow to embrace advanced information technology systems and methodologies to increase efficiency and better manage the business.

Paradoxically, the real estate industry is among the oldest of businesses to rely to a significant extent on an extensive, richly populated database—the Multiple Listing Service (MLS). As is well known in the art, the MLS database(s) include a wide variety of information related to listings, or properties for sale. The data include, for example, the type of property, the features of the property, its location, the asking price, the listing agent/broker, and the like. Additionally, the MLS includes data related to the sale of the property, such as the date of contract, the date of closing, the sale price, the selling agent/broker, and the like. Actual MLS databases are regional in extent, and are maintained and managed by private entities such as a private business, a Board or Association of REALTORS, a trade association, or the like. However, in any given geographic area in the United States or Canada, there is at least one primary MLS database, and it is common in the art to refer to MLS databases collectively, as herein, as “the” MLS.

While virtually all real estate businesses subscribe to the MLS, and utilize the database in the day to day operation of the business, MLS data is not utilized by real estate business managers to generate strategic plans, set goals, define and track measures of progress and business efficiency, evaluate performance, and the like, of their own businesses. That is, real estate businesses primarily utilize MLS to list their own properties, and to discover and analyze properties listed by others in an effort to sell them to clients.

It is known in the art for agents and brokers to utilize MLS data in a rudimentary manner to assist in pricing properties. MLS data is also utilized by facilities management personnel to perform comparative analyses of selected properties, for tax purposes, assessments, determination, to inform investment decisions and the like. It is also known to perform statistical analysis on aggregate MLS data to forecast projected housing needs for planning and urban development, and the like. However, no prior art MLS data analysis systems or methods utilize advanced data mining, statistical analysis and sophisticated display views to provide powerful tools to facilitate and improve the management of real estate businesses.

### SUMMARY

In one or more embodiments, data extracted from the Multiple Listing Service (MLS) database is mined to analyze and display real estate market growth.

One embodiment relates to a method of data mining to analyze and display real estate market growth. A plurality of selection criteria that define a real estate market is accepted and two time period definitions are also accepted. Data associated with properties in the defined real estate market sold during the two time periods and retrieved from one or more MLS databases are aggregated. The data are analyzed to determine the growth in the defined real estate market between the two time periods and indications of the growth are graphically displayed. The displays may be as percent change or change in value of a metric, and may comprise single and double bar graphs, respectively. The metrics may include dollar volume, number of units, median price, average commission and average days on market.

### BRIEF DESCRIPTION OF DRAWINGS

FIG. 1 is block diagram of a hierarchical real estate enterprise.

FIG. 2 depicts a Market Growth Search wizard.

FIG. 3 depicts a Market Growth view graphing Percent Growth by Dollar Volume.

FIG. 4 depicts a Market Growth view graphing Change-in-Value by Dollar Volume.

FIG. 5 depicts a Market Growth tabular view.

FIG. 6 depicts an Office Growth view graphing Percent Growth by Dollar Volume.

### DETAILED DESCRIPTION

In one or more embodiments, the present invention comprises an integrated software suite of ad hoc data mining and analysis tools, incorporating a novel, intuitive display and user interface, to facilitate and improve the management of real estate businesses by analyzing and displaying real estate market growth metrics. The tools operate consistently at the level of an individual agent, a real estate office comprising a plurality of agents, a regional conglomerate of real estate offices, and a national or international enterprise of real estate offices. The primary database accessed by software according to one or more embodiments is the Multiple Listing Service (MLS) of the real estate industry. While real estate businesses traditionally use the MLS to list properties for sale and to search for properties to buy, one or more embodiments disclosed herein mines, analyzes and aggregates data from the MLS to provide valuable information regarding market growth, to promote efficiency and facilitate goal-oriented management techniques for real estate agents, brokers, managers, and executives.

Extensive data are periodically (e.g., daily) extracted from the MLS, and maintained in a local database, such as on a LAN server. This local database is accessed to extract, aggregate and analyze data in support of real estate business management. The local database assures availability and high-speed access to the relevant data. Storing the data locally additionally allows for tracking certain information over time for which historical data is not retained in the MLS database, such as all modifications to the listing price of a property. Accordingly, although data is referred to herein as being extracted from one or more MLS databases, it is understood that the MLS may be the ultimate source of the data, but that the software may actually operate on a local database, such as on a LAN server. Indeed, the present invention is applicable to any database that maintains real estate listing and sales data, and is not limited to a database marketed or referred to as an MLS.

A significant feature of one or more embodiments is the ad-hoc availability of information. Services known in the art extract data from the MLS, and provide, e.g., monthly views of overall market trends, such as the average price of certain classes of properties or the like. These analyses are inherently historic, packaging and presenting data from the previous month or quarter. The displays are static, comprising printed charts and graphs. In contrast, the aggregation and analysis of data according to embodiments of the present invention is performed on an ad hoc basis—at the user's request. The local database is routinely updated (e.g., daily), so the information is always recent, although it may not be strictly “real-time.” As used herein, the term ad hoc means impromptu, or at the user's whim, accessing recent data.

### Hierarchical Real Estate Business

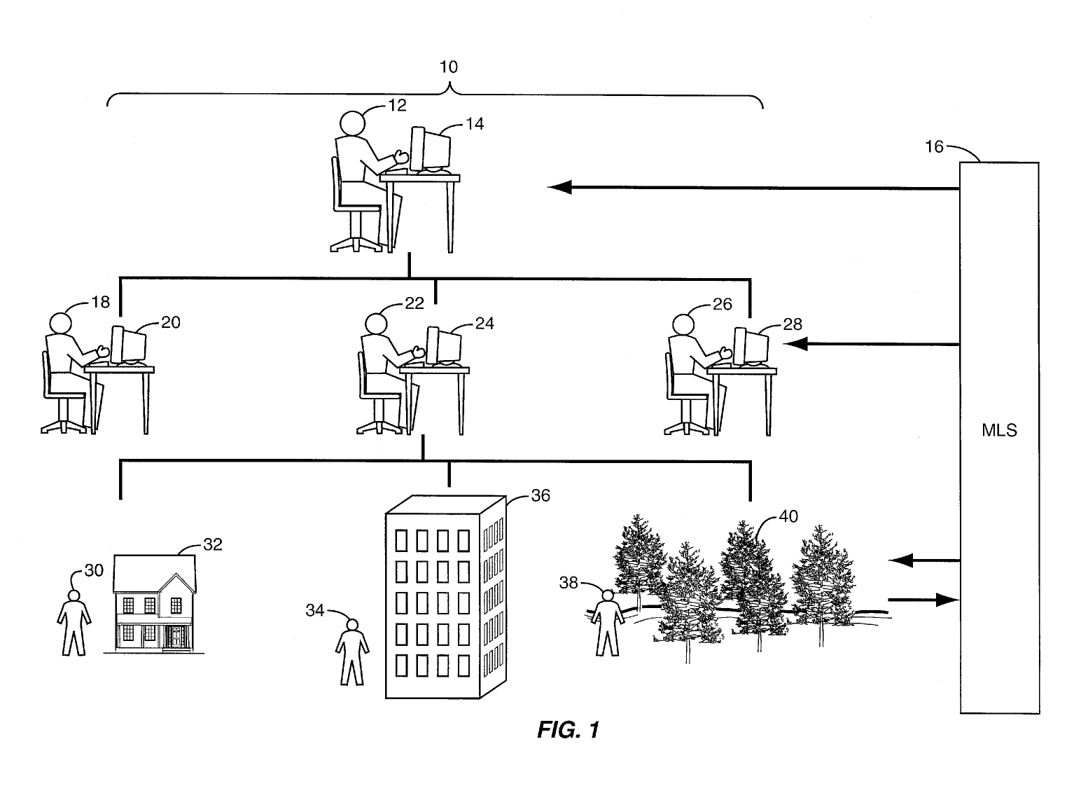

FIG. 1 depicts an organizational diagram of a real estate business having a hierarchical management structure and including a plurality of units. In one embodiment, a regional or national real estate enterprise 10 comprises an enterprise level manager 12 viewing data displayed on a terminal 14, such as a personal computer capable of reading software from a computer-readable medium (not shown). The enterprise level manager 12 views various aggregations and displays of data extracted from the MLS database 16. This organizational level is referred to herein as the enterprise level. The view of FIG. 1 is functional; in any given embodiment, the MLS database may not be a single entity (particularly at the enterprise level), but may comprise an aggregation of a plurality of regional MLS databases. Additionally, FIG. 1 does not depict the local database that resides between the MLS database and the users.

At a hierarchical level below the enterprise level manager 12 are a plurality of real estate office managers 18, 22, 26, each viewing data displayed on terminals 20, 24, 28, respectively. These terminals 20, 24, 28 each display various aggregations and displays of data extracted from the MLS database 16. This organizational level is referred to herein as the office level.

At a hierarchical level below the each real estate office manager 18, 22, 26 are a plurality of real estate agents 30, 34, 38 (only agents 30, 34, 38 managed by the real estate office manager 22 are depicted in FIG. 1). The agents 30, 34, 38 list and sell a variety of properties through the MLS system, such as residential properties 32, commercial properties 36 and unimproved properties 40. The agents 30, 34, 38 cause alterations in the MLS database 16 by virtue of their listing and selling activities. In addition, according to one or more embodiments, the agents 30, 34, 38 may extract and view various aggregations and displays of data extracted from the MLS database 16. This organizational level is referred to herein as the agent level.

Those of skill in the art will recognize that FIG. 1 is representative only, and that a given real estate business 10 may include more or fewer levels of hierarchy, and any number of units at each hierarchical level. For example, a plurality or regional managers (not shown) may be interposed between the enterprise level manager 12 and the real estate office managers 18, 22, 26. Alternatively, the entire real estate business 10 may comprise only one level of hierarchy, such as a single real estate office. In addition, the depicted functional division between agents 30, 34, 38 and real estate office managers 18, 22, 26 is not limiting. For example, one or more real estate office managers 18, 22, 26 may be a broker who himself or herself lists and sells properties 32, 36, 40, and hence alters the MLS database 16.

### Consistent User Interface over Plural Levels of Aggregation

A significant feature of one embodiment is similar functionality and a consistent user interface across multiple hierarchical levels of operation, such as for example, agent, office, regional, and enterprise. An individual may utilize this embodiment to analyze and track his or her own listings, define personal performance metrics and measure and track performance against them over time, and define and track efficiency metrics to improve his or her efficiency. Furthermore, according to functionality disclosed and claimed herein, an individual may use one or more embodiments of the present invention to define a particular real estate market in terms of geographic area and property type, and analyze the growth in that market over various time periods.

A manager of a real estate office comprising a plurality of real estate agents may utilize an embodiment in a similar fashion, aggregating data relating to all agents in the office to track and improve overall office efficiency and productivity. The office manager may additionally define markets and analyze growth in those markets to better target and focus operations, to track competitors, for strategic planning, and the like.

Similarly, one or more embodiments aggregate data to facilitate and support the business management of a regional real estate enterprise or regional division of a national or international real estate business enterprise. The display and user interface of the regional level aggregation of data, according to one embodiment, is directly analogous to that at the office and agent level.

Note that while one or more embodiments are described herein with all “views” of the data available at each level of aggregation, this functionality could additionally be included or excluded from any given implementation. Thus, not all data views, displays, or functionality of the each embodiment need necessarily be present in every implementation falling within the scope of the invention.

### Existing Views and Market Growth

A parent application, Ser. No. 11/65,893, incorporated herein by reference in its entirety, describes in detail the Status, Inventory, Production, Measure, and Monitor views of real estate data displayed in various embodiments of an inventive computer program. These views are described in detail at each of the hierarchical levels of Enterprise, Enterprise—Office Analysis, Office, and Office—Agent (Agent Performance or Agent Analysis). The parent application additionally describes the creation of custom markets, and analysis and tracking tools such as Market Share (Totals and Trends) and Market Dynamics. The parent application additionally describes a uniquely powerful Pricing Analysis tool.

The inventors have discovered that the principles embodied in these views—the power of data mining real estate data bases such as the MLS, the advantages of consistent views across hierarchical levels, the intuitive display of complex information, the display of data and metrics in tabular and graphic formats (either integrated together or in the alternative), the ability to “drill down” and view the underlying data for any entity or data point displayed, and the like—are fully applicable to analysis of real estate data to discover, quantify, illuminate, and track growth and growth trends in the real estate market and among real estate offices.

The Market Growth tool provides brokers with an easy and convenient way to measure market growth (and how their operations compare) relative to any of the following criteria: by property type (including bedroom and bathroom functionality); by geography (County, city, MLS area, MLS sublocation area, subdivision, and ZIP code); by price ranges; and by time periods (last 12 mo. vs. previous 12 mo., YTD, QTD, selected quarters, or custom date range)

The metrics analyzed and displayed are common “yardsticks” used in the real estate industry and include: dollar volume, number of units, median price, average commission offered, average DOM (days-on-market), and commission “strata” for both units and dollar volume

The Growth Metrics tool uses a simple criteria selector using common real estate variables. The results are formatted to familiar yardsticks for ease of comprehension. Data and metrics are displayed in two different, yet complementary ways—percent growth and value differential. Various charts include visual measuring bars to make comparisons easy. For example, the market average of a particular metric, or the average for a specified office group, may be superimposed on a graph of that metric for a variety of specific offices, to readily ascertain which offices are leading or lagging the average. Furthermore, data are exported with GIS formatting facilities, further increasing the usefulness of the analysis by allowing for integration with mapping tools.

### Defining the Market

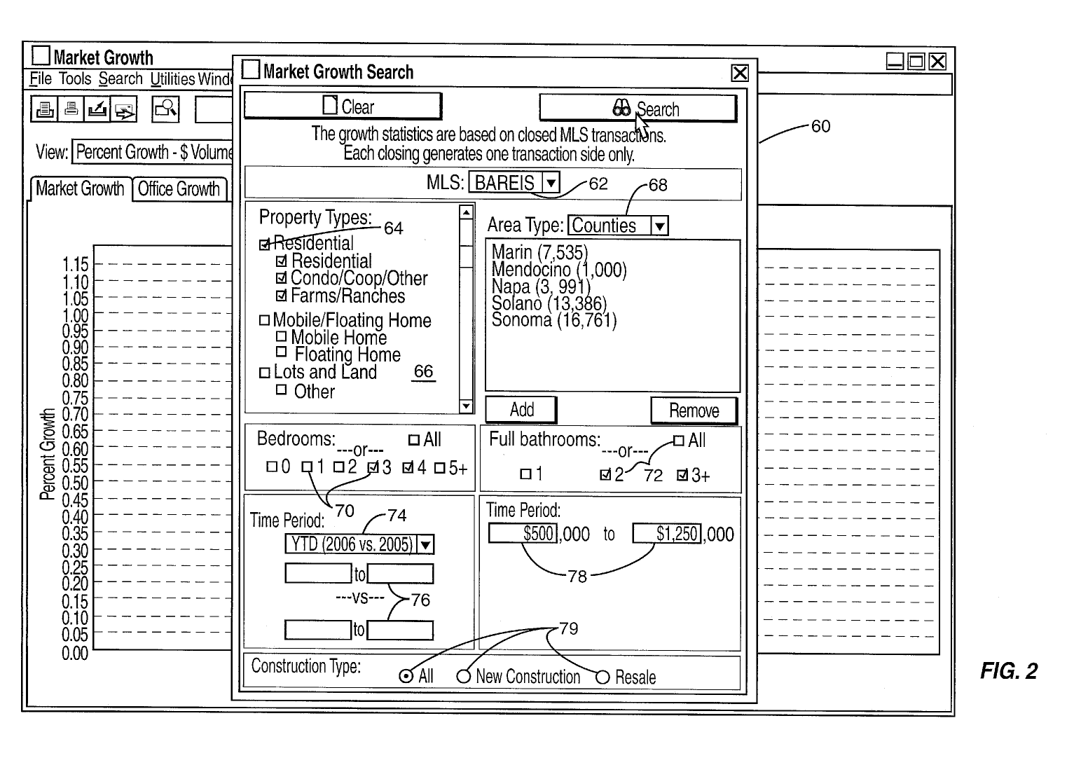

Market Growth analysis begins by defining the market in terms of the types of properties analyzed, their features, geographic areas, and time frames. As depicted in FIG. 2, when the Market Growth view is first selected, a Market Growth Search wizard 60 guides the user through the process of defining a market. The user initially selects an MLS database 16 from a drop list 62, and then selects the property type by checking feature boxes 64 in a scrollable window 66. The property type selection choices precisely “mirror” the fields in the selected MLS database 16. Property type may be, for example, residential, lots and land, or other. In one embodiment, property type is a required field, and there is no default value.

Property type selection at the enterprise level will likely be limited, as it represents an aggregation of data from multiple, regional MLS databases 16, which do not maintain a consistent classification of property types. Hence, specific, detailed property type codes from different MLS's may be grouped into necessarily more generic property type descriptions, that are available at the enterprise level search criteria. Conversely, at the office and agent levels, the property type selection list is likely more extensive, as it includes the specific property types into which the local or regional MLS classifies properties. Note that while in general the office or agent level property type search is more detailed than the enterprise level, the selection choices will vary among different “localizations” of software according to various embodiments, due to different MLS databases 16. However, the property types will match those the office manager is used to, as they reflect the local MLS classifications. A representative list of office or agent level property type search criteria may include residential, multi-unit, commercial, lots and land, mobile homes, commercial office, commercial industrial, agricultural and the like.

The user then selects the area for which data relating to sales of the selected property types is gathered. Area type, selected by drop list 68, may include cities, counties, MLS areas, or zip codes. Cities and counties bring up a list (not shown) from which the user may select one or more entries. The list may be sorted alphabetically or by record count.

Additional search criteria may be selected, such as the number of bedrooms and full bathrooms, by check boxes 70, 72, respectively. The date range may be selected from a drop list 74, including for example LTM vs. PTM (last twelve months vs. previous twelve months), YTD, QTD, and various quarters, which compare the selected time periods for specified years (generally, this year vs. last year). Alternatively, two specific Custom date ranges for comparison may be entered into date windows 76. Price range windows 78 are blank by default. Upper and lower limits are entered by the user, and may be limited to increments of one thousand. The construction type (New Construction, Resale, or All) may optionally be specified by selecting the corresponding radio button 79.

### Market Growth Views

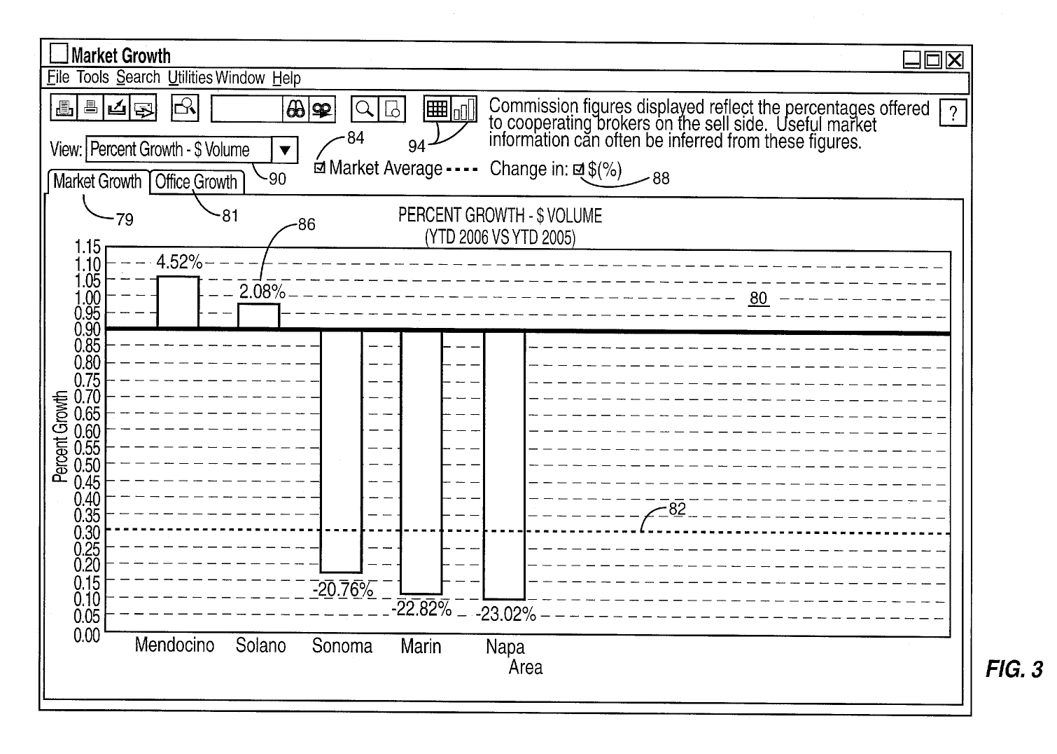

Once the search is run against user-supplied criteria, two categories of Market Growth views are available: Percent Growth and Change-in-Value. Both categories of Market Growth views are selected by clicking the Market Growth tab 79 (FIGS. 3-6).

FIG. 3 depicts a representative Percent Growth view 80 (this one being Percent Growth of the metric Dollar Volume), depicting, as a bar graph, the percent growth between the two specified time frame of the sale of properties matching the selected types and parameters in each of the selected areas. The market average of all the selected areas is optionally displayed for reference, as a line graph 82, by selecting check box 84. The market average graph 82 allows a user to easily see which of the displayed areas is leading or lagging the average in the growth metric graphed. The numerical display 86 of the value of the metric is optionally displayed by selecting check box 88. Additional views of Percent Growth, selected by drop list 90, display metrics such as Number of Units, Median Cost, Average Commission, and Average DOM.

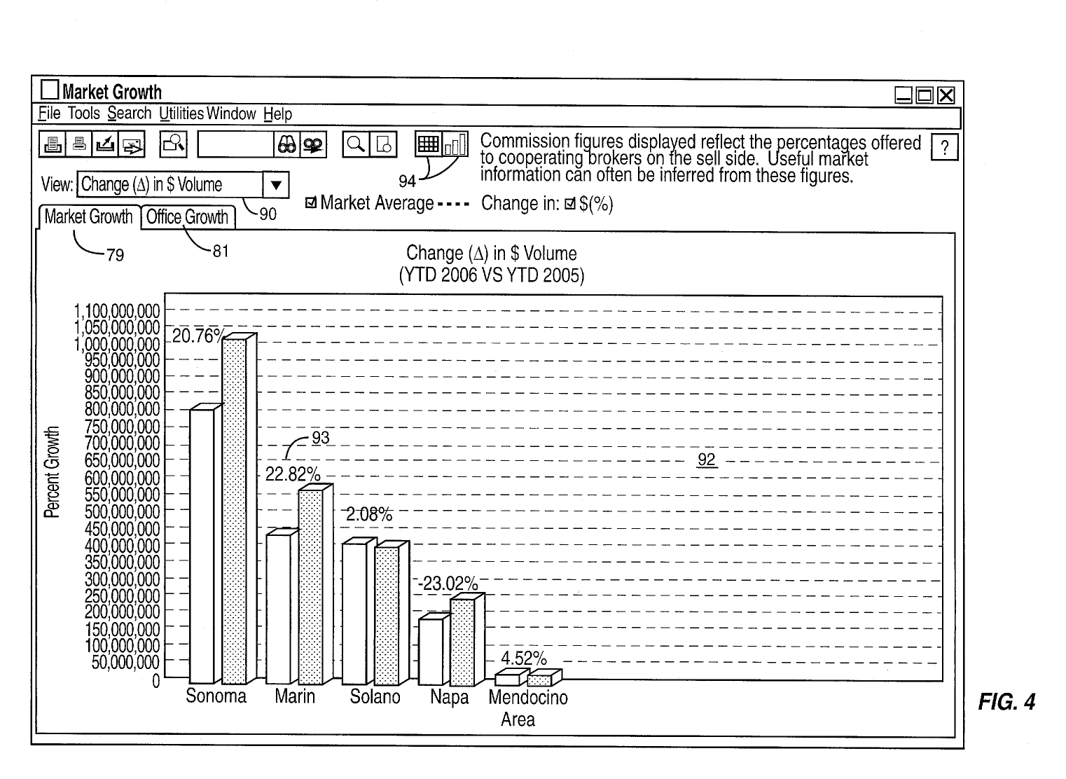

FIG. 4 depicts a representative Change-in-Value view 92 (this one being Change in the metric Dollar Volume), depicting, as a double bar graph, the different values of a metric over the specified time periods for properties matching the selected types and parameters in each of the selected areas. The difference in bar heights for each area reflect the change in the metric, making it easy to see which areas are growing and which are declining. In addition, the bar “heights” indicate the relative “size” of the market for the time period chosen. Additional Change-in-Value views, selected by drop list 90, include the metrics Number of Units, Median Cost, Average Commission, and Average DOM.

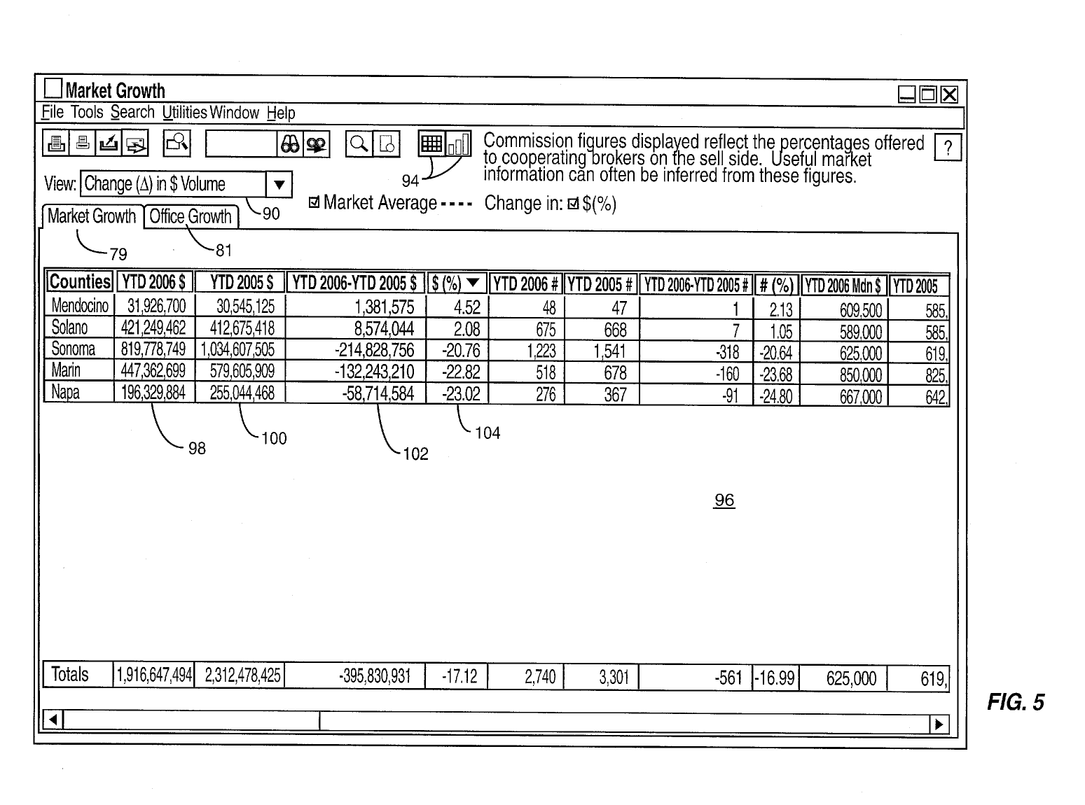

Toggle buttons 94 switch the display between a graph 80, 92, and a tabular display 96, as depicted in FIG. 5, of all data underlying the graphs 80, 92. For example, FIG. 5 depicts, on a separate row for each selected geographic area, the YTD dollar volume for 2006 in column 98, for 2005 in column 100, the difference in dollar volume in column 102 and the difference as a percent in column 104. A corresponding Percent Growth of the metric Dollar Volume view 80 graphs the data in column 104. A corresponding Change-in-Value of the metric Dollar Volume view 92 graphs values from columns 98 and 100 as the heights of twin bars for each area. The value of the difference in column 102 is the difference in height of the bars, and is displayed numerically as a percentage 93, if the numerical display is selected. Similarly, the next four columns contain the data graphed in the Percent Growth and Change-in-Value views of the metric Number of Units. The table 96 allows a user to inspect the data underlying all the graphs.

In one embodiment, the tabular display 96 includes data that is not graphed in any Market Growth graphic view. For example, the display 96 may include the “frequency” and “size” of commissions over the selected time periods in the selected areas, e.g., in columns with headings such as #@0-1.0% (number of commissions in the range from 0 to 1.0%); #@1.01-1.50% (number of commissions in the range from 1.01% to 1.50%); and so forth. Additional columns may display commission information by dollar amount, such as $ @0-1.0% (dollar amount of commissions in the range from 0 to 1.0%); $ @1.01-1.50% (dollar amount of commissions in the range from 1.01% to 1.50%); and so forth.

From the tabular display 96, a user may drill down to view the real estate offices contributing to the metrics displayed for each selected area, such as by right-mouse clicking on the row. In one embodiment, this opens a window (not shown) displaying a tabular view of every real estate office that contributed to the market activity in the corresponding geographic area. The offices that are physically within the area may be highlighted. In one embodiment, the largest office (in terms of the number of agents) in the geographic area is uniquely highlighted (such as by using a different shade or color). The tabular view of real estate offices may include the office name, address, and the metrics displayed in the tabular display 96 for that office—e.g., dollar volume, number of units, commissions, DOM, etc., over the specified time periods.

A user may further drill down by right-mouse clicking on a row associated with a real estate office, to view the individual listings that contributed to the market growth metrics for that office. The listings may be displayed in a separate window (not shown), which may for example display a table, one property per row, listing the property address, sales date, price, commission, DOM, and the like. The data in the listings and real estate office tabular views may be exported, such as in Comma-Separated Value (CSV) format.

### Office Growth Views

In addition to powerful, intuitive views of familiar parameters indicating the growth of the real estate market by geographic area, growth may additionally be analyzed and displayed by real estate offices and groups of offices. According to one embodiment, a user may define their market in terms of competitors, and data mine the MLS data related to those competitors to analyze and visualize growth in the market in a variety of ways. This is a powerful tool for competitive analysis and to identify the leading real estate offices. Office Growth views are selected by tab 81.

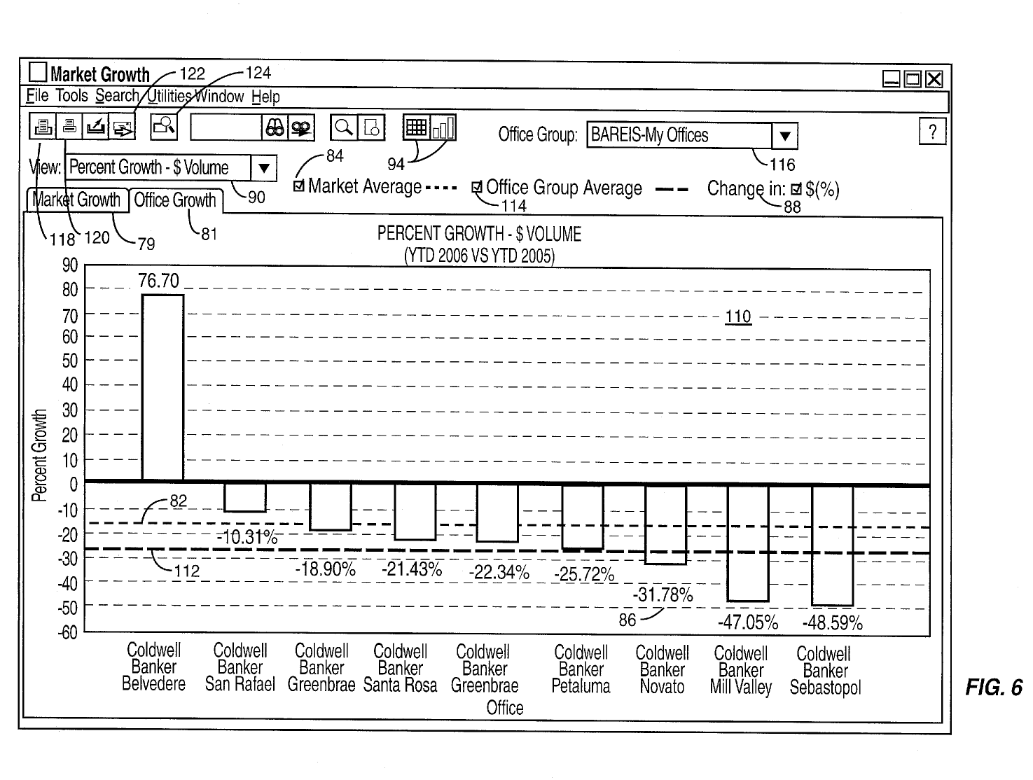

FIG. 6 depicts an Office Growth view 110 (in this case, Percent Growth of the metric Dollar Volume). The view 110 comprises a bar graph of the percent growth of the metric dollar volume of sold properties listed by each of the displayed real estate offices. The market average line graph 82 may be displayed, selected by checkbox 84. Additionally, an “office average” line graph 112 displaying the average growth of the displayed real estate offices may be displayed by selecting checkbox 114. Display of the numerical value 86 of the percent change may be toggled by selecting checkbox 88. Office Growth views may include all views defined for Market Growth—that is, both Percent Growth and Change-in-Value views of metrics such as Dollar Volume, Number of Units, Average Commissions, and Average DOM.

By default, growth data for the top ten offices in the selected areas, as measured by the selected metric, are displayed. Toggle button 94 may be selected to display a tabular view (not shown), with one real estate office per row, with the columns holding the data underlying the graphic displays, as described above with respect to Market Growth tabular view 96. By default, the rows are sorted by the selected metric, and the top ten offices (that is, the ones displayed in the corresponding graphic view 110) are highlighted or otherwise indicated. Additional offices may be displayed by selecting the corresponding rows; upon returning to the graphic view 110, the additional offices are added to the bar graph.

Office groups may be selected from the drop list 116. New office groups may be defined, allowing the user to create customized groups of real estate offices for tracking. In one embodiment, a wizard (not shown) facilitates office group definition by providing a display of all real estate offices listed in the MLS database 16, which may be sorted by, e.g., name, location, dollar volume of listings, number of agents, and the like. Real estate offices are selected and added to the customized group, which is named and then appears in the drop list 116.

### Report Generation and Data Export

In one embodiment, the software generates PDF files containing the graphic and/or tabular data displayed. These reports may be previewed by selecting the Print Preview button 118; printed by selecting the Print button 120, saved to a file via the standard Windows File menu, or exported as an e-mail attachment by selecting the E-Mail button 124. The data may be saved in CSV format by selecting the Export button 122. The Market Growth Search button 126 launches of the search wizard 60, allowing the user to easily clear a prior market definition and define a new market for subsequent growth analysis.

### Advantages of the Various Embodiments of the Present Invention

The present invention, according to one or more embodiments thereof, represents an entirely new level of business intelligence and performance management tools for the real estate industry. Disparate data available to brokers is aggregated and turned it into clear, concise and meaningful information regarding market growth that is quickly and readily absorbed, and can be used at every level of the organization to affect outcomes. Armed with market growth information, brokers can navigate any real estate market more effectively. The market growth tool provides vital information that can improve operations, strategic planning, and sales efforts.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention.

What is claimed is:

1. A method of data mining to analyze and display real estate market growth, comprising:
accepting a plurality of selection criteria that define a real estate market;
accepting two time period definitions;
aggregating data associated with properties in the defined real estate market sold during the two time periods, the data retrieved from one or more real estate databases;
analyzing the data to produce one or more metrics indicative of the growth in the defined real estate market between the two time periods; and
graphically displaying the metrics.

2. The method of claim 1 wherein the plurality of selection criteria that define a real estate market include one or more geographic areas.

3. The method of claim 2 wherein geographic areas are defined in a manner consistent with area definition in the MLS database.

4. The method of claim 2 wherein geographic areas are defined by zip code.

5. The method of claim 1 wherein the plurality of selection criteria that define a real estate market includes property type.

6. The method of claim 1 wherein the plurality of selection criteria that define a real estate market includes number of bedrooms.

7. The method of claim 1 wherein the plurality of selection criteria that define a real estate market includes number of full bathrooms.

8. The method of claim 1 wherein the plurality of selection criteria that define a real estate market includes a price range.

9. The method of claim 1 wherein the plurality of selection criteria that define a real estate market includes specification of construction type as New Construction or Resale.

10. The method of claim 1 wherein graphically displaying the metrics comprises displaying the percent change of a metric between the two time periods as a single bar graph, each bar associated with a geographic area of the defined real estate market.

11. The method of claim 10 wherein graphically displaying the metrics further comprises optionally displaying the percent difference of the metric as a numerical value for each geographic area of the defined real estate market.

12. The method of claim 10 wherein graphically displaying the metrics further comprises optionally displaying the average percent difference of the metric across all geographic area of the defined real estate market as a line graph.

13. The method of claim 10 wherein the metric is dollar volume.

14. The method of claim 10 wherein the metric is number of units.

15. The method of claim 10 wherein the metric is median price.

16. The method of claim 10 wherein the metric is average commission.

17. The method of claim 10 wherein the metric is average days on market.

18. The method of claim 1 wherein graphically displaying the metrics comprises displaying a metric for each of the two time periods as a double bar graph, each pair of bars associated with a geographic area of the defined real estate market.

19. The method of claim 18 wherein graphically displaying the metrics further comprises optionally displaying the percent difference of the metric between the two time periods as a numerical value for each geographic area of the defined real estate market.

20. The method of claim 18 wherein the metric is dollar volume.

21. The method of claim 18 wherein the metric is number of units.

22. The method of claim 18 wherein the metric is median price.

23. The method of claim 18 wherein the metric is average commission.

24. The method of claim 18 wherein the metric is average days on market.

25. The method of claim 1 wherein graphically displaying the metrics comprises displaying the difference in sales in each geographic area of the defined real estate market between the two time periods as a percent change in the dollar volume.

26. The method of claim 1 wherein graphically displaying the metrics comprises displaying the difference in sales in each geographic area of the defined real estate market between the two time periods as a percent change in the number of units.

27. The method of claim 1 wherein graphically displaying the metrics comprises displaying the difference in price for sales in each geographic area of the defined real estate market between the two time periods as a percent change in the median price.

28. The method of claim 1 wherein graphically displaying the metrics comprises displaying the difference in commissions for sales in each geographic area of the defined real estate market between the two time periods as a percent change in the average commission.

29. The method of claim 1 wherein graphically displaying the metrics comprises displaying the difference in listing times for sales in each geographic area of the defined real estate market between the two time periods as a percent change in the average days on market.

30. The method of claim 1 wherein graphically displaying the metrics comprises displaying the dollar volume of sales in each geographic area of the defined real estate market for each of the two time periods.

31. The method of claim 1 wherein graphically displaying the metrics comprises displaying the number of units sold in each geographic area of the defined real estate market for each of the two time periods.

32. The method of claim 1 wherein graphically displaying the metrics comprises displaying the median price of properties sold in each geographic area of the defined real estate market for each of the two time periods.

33. The method of claim 1 wherein graphically displaying the metrics comprises displaying the average commission for sales in each geographic area of the defined real estate market for each of the two time periods.

34. The method of claim 1 wherein graphically displaying the metrics comprises displaying the average number of day on market for sales in each geographic area of the defined real estate market for each of the two time periods.

35. The method of claim 1 wherein the plurality of selection criteria that define a real estate market includes one or more real estate offices, and wherein graphically displaying the metrics comprises displaying the percent change of a metric between the two time periods as a single bar graph, each bar associated with a real estate office.

36. The method of claim 35 further comprising saving the selected real estate offices as a named group, and wherein accepting a plurality of selection criteria that define a real estate market comprises accepting the named group of real estate offices.

37. The method of claim 1 wherein the plurality of selection criteria that define a real estate market includes one or more real estate offices, and wherein graphically displaying the metrics comprises displaying a metric for each of the two time periods as a double bar graph, each pair of bars associated with a real estate office.

38. The method of claim 1 further comprising displaying numeric metrics in a tabular format.

39. The method of claim 38 wherein the numeric metrics are the numeric values of the metrics that are graphically displayed.

40. The method of claim 38 wherein the numeric metrics comprise the number of commissions earned in a plurality of predefined commission ranges in the defined real estate market over the two time periods.

41. The method of claim 38 wherein the numeric metrics comprise the dollar value of commissions earned in a plurality of predefined commission ranges in the defined real estate market over the two time periods.

42. The method of claim 1 further comprising printing numeric or graphic metrics indicative of the growth.

43. The method of claim 1 further comprising exporting metrics in PDF format.

44. The method of claim 1 further comprising exporting metrics in CSV format.

45. The method of claim 1 wherein the real estate database comprises one or more Multiple Listing Service (MLS) databases.

46. A computer-readable medium which stores computer-executable process steps for analyzing and displaying metrics related to real estate market growth, said computer-executable process steps causing a computer to perform the steps of:
accepting a plurality of selection criteria that define a real estate market;
accepting two time period definitions;
aggregating data associated with properties in the defined real estate market sold during the two time periods, the data retrieved from one or more real estate databases;
analyzing the data to produce one or more metrics indicative of the growth in the defined real estate market between the two time periods; and
graphically displaying the metrics.

47. The computer-readable medium of claim 46 wherein graphically displaying the metrics comprises displaying a percent change in a metric between the two time periods.

48. The computer-readable medium of claim 47 wherein displaying a percent change in a metric between the two time periods comprises displaying a bar chart depicting the percent change for each geographic area in the defined real estate market.

49. The method of claim 47 wherein the metric is dollar volume.

50. The method of claim 47 wherein the metric is number of units.

51. The method of claim 47 wherein the metric is median price.

52. The method of claim 47 wherein the metric is average commission.

53. The method of claim 47 wherein the metric is average days on market.

54. The computer-readable medium of claim 46 wherein graphically displaying the metrics comprises displaying the value of a metric for each of the two time periods.

55. The computer-readable medium of claim 54 wherein displaying the value of a metric for each of the two time periods comprises displaying a double bar chart depicting the value of the metric for each time period for each geographic area in the defined real estate market.

56. The method of claim 54 wherein the metric is dollar volume.

57. The method of claim 54 wherein the metric is number of units.

58. The method of claim 54 wherein the metric is median price.

59. The method of claim 54 wherein the metric is average commission.

60. The method of claim 54 wherein the metric is average days on market.

61. The method of claim 46 wherein the real estate database comprises one or more Multiple Listing Service (MLS) databases.
